(19) United States
(12) Patent Application Publication
(10) Pub. No.: US 2004/0128217 A1
(43) Pub. Date: Jul. 1, 2004

(54) Method for assessing the economic earnings performance of a business enterprise

(76) Inventors: Robert E. Friedman, Roseland, NJ (US); David M. Blitzer, New York, NY (US); Howard J. Silverblatt, North Caldwell, NJ (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/285,676

(22) Filed: Nov. 1, 2002

(51) Int. Cl. G06F 17/60

(52) U.S. Cl. 705/35

(57) ABSTRACT

Period economic earnings performance of a business enterprise is calculated using only those revenues generated by the enterprise's stipulated commercial activities and the expenses realized, directly or indirectly, in the generation of those revenues. Income and expenses generated by activities of the enterprise that are extraneous to the stipulated commercial activities are excluded from the calculation of the enterprise's period earnings. According to one implementation, earnings performance is calculated according to the present invention by starting with the enterprise's as-reported earnings, calculated in accordance with Generally Accepted Accounting Principles, and making adjustments to the as-reported earnings to include certain specified items that were not included in the as-reported earnings and to exclude other specified items that were included in the as-reported earnings.

### FIELD OF THE INVENTION

The invention relates to a method for assessing period earnings performance generated by a business enterprise's stipulated commercial activities.

### BACKGROUND

Over the last decade, intensifying pressure to meet investor earnings expectations led more and more companies to introduce new and different earnings measures and reporting approaches. At the same time, many members of the investment community expressed concern that earnings reports have become less representative of the company's underlying earnings performance and more difficult to compare across companies, thereby rendering them less useful to analysts and investors. A number of high-profile bankruptcies and accounting investigations have renewed investors' concerns about the reliability and transparency of corporate reporting.

Earnings measures currently in use

A review of past business accounting and earnings reporting practices has identified three general measures of earnings: as-reported earnings, operating earnings, and proforma earnings. All three measures have uses in the appropriate settings.

These measures, their use, and their meaning are summarized here:

As-Reported Earnings: As-reported earnings are defined as net income according to Generally Accepted Accounting Principles (GAAP). The term GAAP describes broadly the body of principles that governs the accounting for financial transactions underlying the preparation of financial statements. GAAP is largely delineated by the Financial Accounting Standards Board (FASB) through its Statements of Financial Accounting Concepts (SFAC) (incorporated by reference) and Statements of Financial Accounting Standards (SFAS) (incorporated by reference). GAAP is also derived from opinions of the Accounting Principles Board (incorporated by reference), the predecessor of the FASB, and promulgations of the American Institute of Certified Public Accountants (incorporated by reference).

Calculation of as-reported earnings performance includes all revenues, gains, expenses, and losses, except those related to discontinued operations, the impact of cumulative accounting changes, and extraordinary items, as defined by GAAP. This is the statutorial earnings measure and has a long history, having been used for the Standard & Poor's (S&P) 500 and company analyses for decades.

The Financial Accounting Standards Board promulgates accounting standards for a variety of users of financial information, including creditors, auditors, and regulators, as well as investors. Accordingly, the as-reported methodology is all-inclusive in the sense that few items are not included in the calculation of as-reported earnings. Thus as-reported earnings may obfuscate the true underlying economic earnings generated by the company's core trade or business that investors need as a platform for assessing the investment value of a particular company.

Operating Earnings: This measure focuses on revenues and expenses based on the frequency of their occurrence. Operating earnings are usually considered to be as-reported earnings with some charges reversed to exclude large and/or infrequent charges, which are often discretionary. In general, revenues and expenses that are recognized on a relatively frequent basis are included in the calculation of operating earnings, and revenues and expenses that are recognized on a relatively infrequent basis are excluded in the calculation of operating earnings, without regard to whether the revenues and/or expenses are related to the stipulated commercial activities of the business enterprise. Another problem with historical operating earnings definitions is that they lack a consistent definition. That is, what constitutes an infrequent versus a not infrequent item is typically left to the discretion of management, and thus the calculation of operating earnings excludes charges and expenses that management believes are one-time or non-recurring and that management wishes to portray as rare and unusual. Truly rare or unusual items would be classified as extraordinary items under GAAP. The charges excluded from operating earnings are often charges that are neither rare, one-time, nor non-recurring - just charges some would prefer to forget.

Pro Forma Earnings: Originally, the use of the term pro forma meant a special analysis of a major change, such as a merger, where adjustments were made for an “as if” review. For example, in the case of a recently merged company, pro formna earnings may be calculated by combining the pre merger earnings of the two companies as if they had been merged. In such cases, proforma measures are very useful. However, the specific items being considered in an “as if” review must be clear. In some recent cases, “as if” has come to mean “as if the company didn't have to cover proper expenses.” Moreover, pro forma measures are not consistent and clearly defined across all industries.

Such abuses notwithstanding, proforma earnings do have a place and can be used for special analyses of potential changes in a corporation. In such cases, pro forma earnings arc defined for the particular analysis.

Accordingly, a new measure of business earnings is needed which more accurately and consistently reflects the economic condition of a business enterprise vis-a-vis the business enterprise's stipulated commercial activities and is less susceptible to discretionary reporting practices.

### SUMMARY OF THE INVENTION

A methodology is presented for assessing period economic earnings performance of a business enterprise. The methodology provides consistent and transparent calculations of earnings performance that more accurately reflect the true financial condition of the business enterprise with respect to its stipulated commercial activities than presently-used earnings calculations.

In accordance with the present invention, the period earnings performance of a business enterprise is calculated using only those revenues generated by the enterprise's stipulated commercial activities and the expenses realized, directly or indirectly, in the generation of those revenues. Income and expenses that are generated by activities of the enterprise that are extraneous to the stipulated commercial activities are excluded from the calculation of the enterprise's period earnings. According to one implementation, earnings performance is calculated according to the present invention by starting with the enterprise's as-reported earnings, calculated in accordance with Generally Accepted Accounting Principles, and making adjustments to the as-reported earnings to include certain specified items that were not included in the as-reported earnings and exclude other specified items that were included in the as-reported earnings.

Material items that are deemed to be related to the stipulated commercial activities of a business enterprise, and thus are included in the calculation of earnings in accordance with the present invention, include: expenses associated with stock option grants (a form of employee compensation), charges associated with restructuring ongoing commercial operations of the business enterprise, write-downs for depreciable or amortizable operating assets of the business enterprise, certain pension costs, expenses associated with research and development purchased by the business enterprise, merger and acquisition related expenses, and unrealized gains/losses from hedging activities. Conversely, material items that are deemed to arise from activities that are extraneous to the stipulated commercial activities of a business enterprise, and thus are excluded in the calculation of earnings in accordance with the present invention, include: goodwill impairment charges, gains and losses from the sale of assets of the business enterprise, pension gains, litigation or insurance settlements and proceeds, and reversals of prior period charges and provisions.

With these and other objects, advantages, and features of the invention that will become hereinafter apparent, the nature of the invention may be more clearly understood by reference to the following detailed description of the invention and the appended claims.

### DESCRIPTION OF THE DRAWING

FIG. 1 is a table illustrating a pension income calculation and adjustment in accordance with the present invention.

### DETAILED DESCRIPTION

Given the lack of any consistent and accurate definition of operating earnings and the widespread and sometimes inconsistent use of the term, the inventors felt that use of the term operating earnings might only add to the confusion. Therefore, in the context of the present disclosure, the result of the earnings measure methodology set forth herein will be referred to as Core Earnings. Core Earnings refer to the earnings generated by the business enterprise's stipulated commercial activities (i.e., its core trade or business). The term “stipulated commercial activities” refers to commercial activities that the business enterprise lists in regulatory filings and/or financial (e.g., annual) reports as the commercial activity or activities in which the enterprise normally engages.

Since there is a general understanding of what is included in as-reported earnings, the definition of Core Earnings begins with as-reported earnings and then makes a series of adjustments (i.e., inclusions and exclusions). As-reported earnings includes net income determined in accordance with GAAP, with three exclusions-extraordinary items, cumulative effect of accounting changes, and discontinued operations, all as defined by GAAP. In the context of the present disclosure, when an item is excluded from assessing an enterprise's earnings performance, it is not counted in calculating the adjustments to the enterprise's net income. If the excluded item is a cost or an expense, its exclusion makes earnings larger; if the excluded item is revenue or a credit, its exclusion makes earnings smaller. Conversely, when an item is included in assessing an enterprise's earnings performance, it is counted in calculating the adjustments to the business enterprise's net income. If the included item is a cost or an expense, its inclusion makes earnings smaller; if the included item is revenue or a credit, its inclusion makes earnings larger.

Typically, among accountants and financial analysts the term “revenue” refers to monies generated from the sale of a product or service and “income” refers to the difference between revenues and expenses. Similarly, among accountants and financial analysts “expenses” refers to the net assets that are used up by the enterprise during a one year operating cycle, “costs” refers to net assets that are used up over a period of more than one year, and “charges” are expenses that are deemed special due to their size and/or the infrequency of their occurrence. In the context of the present description, however, unless stated otherwise, the terms “expenses”,, “costs”,, and “charges” will be used interchangeably to refer generally to an amount that would subtracted (if a positive number) from revenues if included on an accounting balance sheet, regardless of the size or the frequency of its occurrence.

Where the assessment of Core Earnings according to the present invention requires adjustment for taxes, the tax rate used is preferably the statutory rate for US corporate taxes (i.e., 35%). No adjustment is made for either state and local taxes or for an effective tax rate different from the statutory federal corporate rate.

TABLE 1
shows a sample income statement and provides a definition of as-
reported earnings:

Summary Income Statement
Operating revenues
(Cost of goods and/or services sold)
(Selling, general & administrative expenses)
(Depreciation expense)
Pension gains (costs)
Earnings before interest and taxes
Interest income (expense)
(Amortization expense)
Dividend income
Royalty income
Income before taxes
(Taxes)
Reported Net Income
Discontinued operations
Cumulative effect of accounting changes
Extraordinary items
Net Income

In Table 1, the term Operating Revenues refers to the revenues generated by sales of goods and/or services in accordance with the business enterprise's stipulated commercial activities.

General Approach

The methodology of the present invention focuses on a business enterprise's stipulated commercial activities, otherwise referred to as its core trade or business. In general, assessment of the business enterprise's Core Earnings will include all the revenues and expenses generated by those commercial activities and will exclude gains or losses that arise from activities and endeavors that are extraneous to the business enterprise's stipulated commercial activities. Stated another way, calculation of Core Earnings according to the present invention focuses on the underlying characteristics of the item (revenue or expense) and includes in the calculation only those revenues generated as part of the core trade or business of the enterprise and those direct or indirect expenses realized in the creation of those revenues, regardless of the frequency or size of the revenue or expense.

Calculating Core Earnings in accordance with the methodology described herein comprises making adjustments (i.e., inclusions and exclusions) to the as- reported earnings calculated in accordance with GAAP. The adjustments to the as- reported earnings are made to undo the treatment of items included or excluded in as- reported earnings which the inventors believe obfuscate the true economic earnings performance underlying the stipulated commercial activities of the business enterprise. The items selected for adjustment are items that can have significant impact on the assessment of the business enterprise's earnings performance. Thus, in accordance with the Core Earnings methodology, as-reported earnings are adjusted such that certain items included in the as-reported earnings are excluded (subtracted back out) in the assessment of Core Earnings, and certain items excluded from the as- reported earnings are included (added back in) in the assessment of Core Earnings.

Material items that reflect revenues and costs generated by the stipulated commercial activities of the business enterprise, and thus are included in the determination of Core Earnings, include expenses associated with stock option grants (a form of employee compensation), charges associated with restructuring ongoing commercial operations of the business enterprise, write-downs for depreciable or amortizable operating assets of the business enterprise, certain pension costs, expenses associated with research and development purchased by the business enterprise, merger and acquisition related expenses, and unrealized gains/losses from hedging activities. Items that are considered extraneous to the stipulated commercial activities of the business enterprise, and thus are excluded from the determination of core earnings, include goodwill impairment charges, gains and losses from the sale of assets of the business enterprise, pension gains, litigation or insurance settlements and proceeds, and reversals of prior period charges and provisions.

The specific items that should be included or excluded in assessing Core Earnings are summarized in Table 2 below. Each item is discussed separately in the following sections.

TABLE 2
Items included in and excluded from Core Earnings

| Included in Core Earnings | Excluded from Core Earnings |
|---|---|
| Employee stock option grant expense | Goodwill impairment charges |
| Restructuring charges from ongoing | Gains/losses from asset sales |
| operations | |
| Write-downs of depreciable or | Pension gains |
| amortizable operating assets | |
| Pension costs | Litigation or insurance |
| | settlements and proceeds |
| Purchased research & development | Reversal of prior period charges |
| expenses | and provisions |
| Merger/acquisition related expenses | |
| Unrealized gains/losses from hedging | |
| activities | |

### Items Included In Core Earnings

Employee Stock Option Grant Expense

Stock options are granted to employees as part of their compensation packages. Other components of compensation include salaries, cash bonuses based on individual or corporate performance, medical and other employee benefits, and defined benefit and/or defined contribution pension plans. All parts of employee compensation, including stock options, should be included in Core Earnings.

A stock option gives the employee the right to purchase a stock at specific prices. Because a contractual right has value, so does the stock option, which is just another type of contractual right. Thus, the stock option has value which represents a form of employee compensation, and thereby represents an expense to the employer enterprise. Moreover, the right was given to the employee in consideration for services rendered to the company. As such, the stock option represents an expense to the enterprise realized in generating the revenues related to the stipulated commercial activities of the enterprise, so the fair market value of stock option grants should be included in calculating Core Earnings.

Employee stock option reporting is subject to specific regulations promulgated by the Financial Accounting Standards Board as SFAS 123 (Statement of Financial Accounting Standards No. 123: Accounting for Stock-Based Compensation, Financial Accounting Standards Board, Oct. 1995) (incorporated herein by reference). This rule gives companies the choice of reporting employee stock option expense annually in the income statement or as a footnote in the annual report. Companies determine the cost of employee stock option grants with an option pricing model, such as the Black-Scholes model, and report those costs together with the factors used in the calculations.

Historically, very few companies in the S&P 500 had included employee stock PPDO option grants as an expense in their income statements. Furthermore, this information is often released with fiscal year-end earnings information after releasing the press release reporting annual earnings.

Stock option expenses are typically not included in calculating operating earnings or in calculating as-reported earnings in accordance with GAAP.

### Restructuring Charges From On-Going Operations

These charges should be included in the calculation of Core Earnings, because they represent costs and expenses that will be eventually incurred in the process of creating the products or services that comprise the stipulated commercial activities of the business enterprise.

Restructuring charges from on-going operations are generally defined as hose expenses that arise when a company decides to close plants or other facilities and include expenses, such as employee layoffs, maintenance costs, or early lease terminations. But for the decision to restructure an aspect of the enterprise and eliminate these assets, they would have been used up in the process of creating future operating revenues and thus would have led to future operating expenses. Thus, charges for restructuring these assets should be included in the calculation of Core Earnings. Large-scale employee layoffs and plant closings may suggest that the company does not expect current and future levels of business to support current staffing levels and/or the operation of plants and their attendant machinery and equipment.

Charges associated with restructuring ongoing commercial operations of the business enterprise are typically included in calculating as-reported earnings in accordance with GAAP, but are not included in calculating operating earnings.

### Write-Downs Of Depreciabke Or Amonizabk Operating Assets

Asset write-downs occur when the fair market value of an asset drops below net book value and the enterprise takes a charge on its books. As is convention, depreciable assets refers to diminishment of tangible assets and amortizable assets refers to diminishment of intangible assets. Because the write-down represents the accelerated reduction in the value of assets that would otherwise have been used up in the creation of operating revenues, the write-down, in effect, constitutes an accelerated operating expense and should be included in Core Earnings.

Some write-downs may be large and/or occur infrequently. However, their size or rare occurrence does not change the facts -the assets in question are or were used in generating operating revenues, and the market value of the asset is less than its net book value.

Write-downs of depreciable or amortizable operating assets are typically included in calculating as-reported earnings in accordance with GAAP, but are not included in calculating operating earnings.

### Pension Costs

In a preferred implementation of the present invention, the treatment of pensions described herein applies to defined benefit pension plans and not to other pension plans, such as, 401 (k) plans or other defined contribution plans.

Pension benefits are part of employee compensation, just like salaries, bonuses, other benefits, employee stock option grants, and other forms. Because pension benefits for the employees are obligations which represent costs borne by the enterprise, and thus by its owners (i.e., shareholders where the enterprise is a corporation), these costs constitute an asset used up in the creation of operating revenues and thus most of these costs are included in assessing Core Earnings. Under GAAP, net pension income/expense is calculated as the sum of expected return on plan assets, service cost, interest cost, prior service cost, and net actuarial gain recognized. Expected returns on plan assets are calculated by multiplying the fair market value of the pension plan assets at the beginning of the year by the expected increase in the value of plan assets for the year in question. Service cost refers to the present value of the incremental future benefits that an employee will be entitled to receive upon retirement by working an additional year. Interest cost refers to the increase in value of the business enterprise's benefit liability as time passes and the benefit payment time gets closer. Pension plan amendments may increase (or decrease) previously computed pension benefit obligations. These charges relating to periods of employment prior to the amendments are known as prior service costs. Net actuarial gains (or losses) are the difference between actual returns on plan assets and expected returns amortized over five years.

In accordance with the methodology of the present invention, only service and interest costs are included in the calculation of Core Earnings. Expected returns on plan assets, prior service cost, and net actuarial gain recognized are excluded from the assessment of Core Earnings, and thus these items are excluded (i.e., subtracted) from as-reported earnings.

There are instances in which the interest component of the pension costs are excluded from the Core Earnings assessment and instances in which the interest component of pension costs are included. As mentioned above, interest cost represents the increase in value of the benefit obligation as time passes and benefit payment time gets closer. The actual returns generated by the pension fund represent the investment returns provided by the pension fund to cover these costs. Because, as stated above and described in more detail below, pension gains are excluded from the Core Earnings assessment, to the extent that interest cost is covered by the actual returns generated by the pension fund, interest costs will not be considered a charge against Core Earnings.

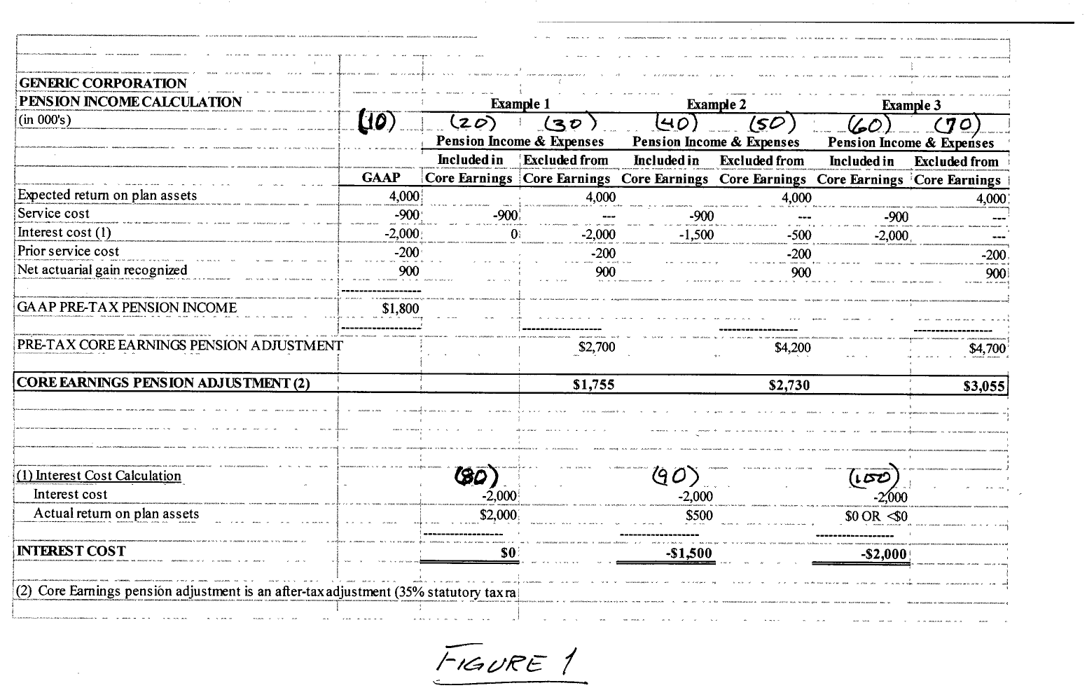

See FIG. 1 for a sample calculation of the preferred Core Earnings pension income adjustment.

Column 10 represents the pension-income calculation that would be performed in deriving as-reported earnings under GAAP. Under GAAP, several components of pension income are included, namely, expected return on plan assets, service cost, interest cost, prior service cost, and net actuarial gain recognized. In calculating Core Earnings according to the present invention, the pension income components of the as-reported earnings calculated in accordance with GAAP are adjusted in accordance with the Core Earnings methodology. In the Core Earnings methodology, as demonstrated in columns 20, 30, 40, 50, 60, and 70, expected return on plan assets, prior service cost, and net actuarial gain recognized are all excluded in their entirety from the earnings calculation. The service cost is included in its entirety in the earnings calculation. The interest cost is excluded only to the extent that the interest cost is offset by an actual return on the pension plan assets.

In example 1, shown under columns 20, 30, and 80, interest costs of $2,000,000 are offset by actual return on plan assets of $2,000,000 (see column 80). Accordingly, the interest costs are completely offset and interest costs of $0 are included in the Core Earnings calculation. The items listed in column 30 are thus excluded from the Core Earnings calculation. In calculating the as-reported earnings under GAAP, each of those items was included. Thus, the pension income of the as- reported earnings calculated under GAAP, is “adjusted” by subtracting from the pension income those items that were included in the GAAP methodology but are excluded in the Core Earnings methodology. In a preferred implementation of the present invention, the Core Earnings pension income adjustment is made as an after-tax adjustment (assuming a 35% statutory tax rate). Thus, the amount that is subtracted from the GAAP pension income is 65% of the sum of the excluded items listed in column 30.

In example 2, represented by columns 40, 50, and 90, the interest cost is again $2,000,000 but the actual return on plan assets is only $500,000 (see column 90). Thus, $1,500,000 of the interest cost is not offset by actual returns on the pension plan assets. Therefore, in addition to the service cost of $900,000, $1,500,000 of interest cost are included in the Core Earnings pension income calculation, as shown in column 40. Again, the pension income calculated under GAAP is adjusted by subtracting the excluded items listed in column 50, preferably on an after-tax basis. Note that the adjustment exceeds the GAAP pension income.

Finally, in example 3, represented by columns 60, 70, and 100, the interest cost is again $2,000,000 but the actual returns on pension plan assets was $0 or less than $0 (see column 100). Accordingly, no amount of the $2,000,000 interest cost is offset by returns on the pension plan assets, and thus the entire $2,000,000 interest cost is included in the Core Earnings calculation. Again, the pension income calculated under GAAP is adjusted in accordance with the Core Earnings methodology by subtracting those items that are excluded (i.e., listed in column 70), preferably on an after-tax basis. Note again that the adjustment exceeds the pension income.

Purchased Research & Development Expenses

Internally conducted research and development costs are included in Core Earnings. Thus, in the normal course of business, purchased research and development costs are also included in Core Earnings as these too represent assets used up in the creation of operating revenues.

Purchased research and development expenses are typically included in calculating as-reported earnings in accordance with GAAP, but are not included in calculating operating earnings.

Unrealized Gains/Losses From Hedging Activities

Protecting the future value of operating assets and liabilities through hedging activities constitutes a core business activity. In addition, management aims to secure certain revenues and costs that are subject to market price variability, or are denominated in foreign currency utilizing hedging activities. Therefore, any unrealized hedging gains or losses represent the success or failure of the company's ability to manage its core business exposures. Accordingly, unrealized gains or losses from hedging activities, as defined in SFAS 133 (Statement of Financial Accounting Standards No. 133: Accounting for Derivative Instruments and Hedging Activities, June 1998) (incorporated herein by reference), should be included in the calculation of Core Earnings. As such gains and losses are typically included in the calculation of GAAP as-reported net earnings, assessment of Core Earnings in accordance with the present invention does not require an adjustment of as-reported earnings to account for unrealized gains and losses from hedging activities.

Merger/Acquisition-Related Expenses

Merger & Acquisition (M&A) activities are normally undertaken to support the business enterprise's stipulated commercial activities. Therefore, any investment banking, legal, and accounting fees and other expenses arising from M&A activities represent assets used up in the generation of operating revenues (albeit indirectly) and should be included in calculating Core Earnings. As M&A expenses are typically included in the calculation of GAAP net earnings, assessment of Core Earnings in accordance with the present invention does not require an adjustment of as-reported earnings to account for such expenses.

### Items Excluded from Core Earnings

Goodwill Impairment Charges

Goodwill represents the difference between the price paid for an acquisition and the fair market value of identifiable assets of the acquisition. New rules for the treatment of goodwill, under SFAS 142 (Statement of Financial Accounting Standards No. 142 Accounting for Goodwill and Other Intangible Assets, Financial Accounting Standards Board, Jun. 30, 2001) (incorporated herein by reference), became effective in 2002. Under these rules, companies do not amortize goodwill. However, companies are required to take a write-off if the goodwill carried on its books is “impaired” -if its market value is less than its book value.

Although SFAS 142 mandates that goodwill and certain other intangible assets should not be amortized in the income statement, GAAP rules mandate that generally, goodwill impairment charges arise to the level of a legitimate expense and should be included in the calculation of earnings. In this regard treatment of goodwill assets has been somewhat inconsistent. Because the goodwill asset will never be amortized, i.e. used up in the creation of operating revenues, goodwill impairment charges are not included in the calculation of Core Earnings. The amortization of goodwill is not considered a period cost expended in the creation of revenues. Thus, the inclusion of goodwill impairment charges would distort the company's operating performance. Since any goodwill impairment implies that the company's earnings will suffer in the future, including a charge for goodwill impairment in Core Earnings would doubly penalize the company's performance. Because goodwill impairment charges are included in the assessment of as-reported earnings calculated under GAAP, calculation of Core Earnings requires that as-reported earnings be adjusted by adding back in any goodwill impairment charges that had been subtracted from the as- reported earnings.

Note that goodwill differs from the depreciation or amortization of assets. In the latter case, there are periodic expenses related to using up assets in the generation of operating revenues, and a write-down changes the timing of these charges; with goodwill, in contrast, there are no periodic charges relating to using up the goodwill “asset”,.

Goodwill impairment charges are typically included (i.e., not excluded) in calculating as-reported earnings in accordance with GAAP, but are excluded in calculating operating earnings.

Gains/Losses From Asset Sales

Gains and losses from sales of assets, including machinery and equipment, real estate, and salable intangible assets, should be excluded from the calculation of Core Earnings. Although the sales of these assets constitute either a gain or a loss to the business enterprise, most business enterprises are not in the business of buying and selling their own operating assets. Thus, the proceeds from a sale of operating assets do not arise to operating revenues.

The exception to this rule is companies whose asset sales arise from the normal course of business. Such companies include financial entities such as banks, mortgage companies, and leasing companies, which buy or sell financial assets such as portfolios of loans or receivables; real estate development companies, which develop real estate properties for resale; and Real Estate Investment Trusts, which buy and sell real estate as part of their principal business. For these companies, gains and losses from assets sales are included in assessing their Core Earnings.

Gains and losses from asset sales are typically included (i.e., not excluded) in calculating as-reported earnings in accordance with GAAP, but are excluded in calculating operating earnings.

Pension gains As mentioned above, the discussion of pension income relates to defined benefit plans. In a defined benefit plan, the enterprise establishes a pension trust that manages financial assets for the benefit of current and future retirees. A pension plan estimates its future liabilities and compares them to its current assets. In some years, investment returns provide the fund with income that exceeds the plan's annual costs. However, these pension gains are the product of the financial markets and the investment skill of the portfolio managers hired to manage the pension trust; they are not a product of the enterprise's stipulated commercial activities.

Moreover, it's important to note that pension gains are not available to the enterprise sponsoring the plan or, in the case of a corporation, to the shareholders of the corporation, except in rare cases where the plan is terminated. Because pension gains are not available to the enterprise, they are excluded in the calculation of Core Earnings.

Some may be concerned that pension income is excluded from Core Earnings, while pension costs are included. This apparent conflict is in reality no conflict at all. The two are not parallel because they arise in different places from different activities. Pension costs are part of employee compensation and arise because people are hired to work and, hopefully, produce revenues and Core Earnings. Pension gains, in contrast, have nothing to do with the enterprise's core trade or business and accrue to the benefit of the business enterprise's employees, not its shareholders. The size and timing of pension gains reflect the skill of the portfolio managers engaged to manage the pension plan and the foresight of the pension plan sponsor in establishing the investment policy and hiring the portfolio managers. Both the gains and the costs are related to the pension plan, but the similarity ends there.

Gains on pension plan assets are typically included (i.e., not excluded) in calculating as-reported earnings in accordance with GAAP, but the treatment of pension gains with respect to calculation of operating earnings has not been consistent.

Litigation or Insurance Settlements and Proceeds

Since gains or losses from litigation settlements do not arise from the normal course of business, such gains or losses are excluded from the calculation of Core Earnings. In the context of the present disclosure, “litigation settlement” includes any type of damage or award received from or paid to an opposing party to a litigation and may result from negotiated settlement, trial verdict, mediation, arbitration, etc. Consistent with this, provisions to boost litigation settlement reserves are excluded from Core Earnings as well. Insurance costs or proceeds, where the insurance is not integral to the enterprise's operations (such as life insurance on employees other than that included in employee benefits), are not part of Core Earnings.

Litigation costs, on the other hand, are considered to be a cost of doing business, and thus are properly included in assessing Core Earnings.

Litigation or insurance settlements and proceeds are typically included (i.e., not excluded) in calculating as-reported earnings in accordance with GAAP, but the treatment of such settlements and proceeds with respect to calculation of operating earnings has not been consistent.

Reversal of Prior Period Charges and Provisions

Occasionally, companies will reverse into current income portions of estimated restructuring charges or other provisions (e.g., bad debt provisions) booked in prior periods, when the estimated restructuring charges or other provisions exceed the actual amount of the restructuring charges or other charges for which provisions were booked. Including the perceived income from these reversals distorts earnings in the period in which it is recognized, because it relates to activities and the expenses of those activities which occurred in prior periods. Therefore, the perceived income from reversal of provisions generated from prior period charges is excluded in calculating Core Earnings.

Although reversal of prior-year charges should be excluded in the calculation of Core Earnings, these reversals should be netted against the original charge. However, because companies' filings and reports do not typically provide sufficient information to completely identify the timing of the earlier charges, or allow one to associate each reversal with a specific prior charge, there is often insufficient data to accurately restate earlier periods. Further, any decision about restating earlier years must make a tradeoff between maintaining data that reflect the way the markets perceived companies at the time and imposing adjustments on prior years' data that were unknown until long after the fact.

Reversals of prior period charges and provisions are typically included (i.e., not excluded) in calculating as-reported earnings in accordance with GAAP, but the treatment of such reversals with respect to calculation of operating earnings has not been consistent.

While the invention has been described in connection with what are presently considered to be the most practical and preferred implementations, it is to be understood that the invention is not to be limited to the disclosed implementations, but, on the contrary, is intended to cover various modifications and equivalent methodologies included within the spirit and scope of the appended claims.

1. A method for assessing economic earnings of a business enterprise for a given period, said method comprising:
(a) including expenses associated with granting stock options to employees of the business enterprise;
(b) including expenses associated with restructuring ongoing commercial operations of the business enterprise;
(c) including write-downs of depreciable or amortizable assets employed in the commercial operations of the business enterprise;
(d) including at least a portion of the costs incurred in the administration of an employee pension plan for the benefit of employees of the business enterprise;
(e) including expenses associated with research and development purchased by the business enterprise;
(f) including expenses related to mergers and acquisitions;
(g) including unrealized gains and losses from hedging activities;
(h) excluding charges associated with impairment of goodwill of the business enterprise;
(i) excluding gains or losses from sale of assets of the business enterprise if the stipulated commercial activities of the business enterprise do not entail selling a portion of its assets;
(j) excluding gains realized by the employee pension plan;
(k) excluding litigation settlements;
(l) excluding insurance proceeds; and
(m) excluding reversals of prior period charges and reversals of prior period provisions incurred by the business enterprise in a period preceding the given period, wherein, if an item is excluded from assessing the business enterprise's earnings, it is not counted in calculating the earnings, and if an item is included in assessing the business enterprise's earnings, it is counted in calculating the earnings.

2. The method of claim 1, wherein the costs incurred in the administration of the employee pension plan include service costs and interest costs, wherein service costs are included in assessing the business enterprise's earnings, interest costs not offset by actual gains realized on the assets of the employee pension plan are included in assessing the business enterprise's earnings, and interest costs that are offset by actual gains realized on the assets of the employee pension plan are excluded in assessing the business enterprise's earnings.

3. The method of claim 1, further comprising including gains and losses from the sale of specified assets of the business enterprise if the stipulated commercial activities of the business enterprise entail selling at least a portion of the specified assets.

4. A method for assessing economic earnings of a business enterprise for a given period by making specified adjustments to an as-reported earnings assessment calculated for the given period in accordance with Generally Accepted Accounting Principles, said adjustments comprising:
(a) subtracting gains realized by an employee pension plan from the as-reported earnings;
(b) subtracting charges associated with impairment of goodwill of the business enterprise from the as-reported earnings;
(c), subtracting from the as-reported earnings gains and losses from the sale of assets of the business enterprise if the stipulated commercial activities of the business enterprise do not entail selling a portion of its assets;
(d) subtracting any proceeds received from litigation settlement from the as-reported earnings;
(e) subtracting any proceeds from settlement of insurance claims from the as-reported earnings; and
(f) subtracting reversals of prior period charges and reversals of prior period provisions incurred in a period preceding the given period from the as-reported earnings.

5 The method of claim 4, further comprising adding to the as-reported earnings the amount of interest costs associated with administration of an employee pension plan for the benefit of employees of the business enterprise to the extent that the interest costs are not offset by actual gains realized on the assets of the employee pension plan.

6. The method of claim 4, further comprising subtracting stock option expenses incurred during the period from the as-reported earnings.

7. A method for assessing economic earnings of a business enterprise for a given period, said method comprising:
(A) adding operating revenues generated from the stipulated commercial activities of the business enterprise, wherein said operating revenues do not include:
(1) gains realized in an employee pension plan, (2) proceeds received from litigation settlement, (3) proceeds from settlement of insurance settlement, and (4) reversals of prior period charges and reversals of prior period provisions incurred by the business enterprise in a period preceding the given period; and
(B) subtracting from said operating revenues operating expenses realized directly or indirectly in generating said operating revenues, said operating expenses including:
(1) expenses associated with granting stock options to employees of the business enterprise, (2) expenses associated with research and development purchased by the business enterprise, (3) expenses associated with restructuring ongoing commercial operations of the business enterprise;
(4) write-downs of depreciable or amortizable operating assets of the business enterprise, and (5) at least a portion of costs associated with the administration of said employee pension plan.

8. The method of claim 7, wherein the costs associated with the administration of the employee pension plan include service costs and interest costs, wherein said operating expenses include said service costs and a portion of said interest costs not offset by actual gains realized on the assets of the employee pension plan, and said operating expenses do not include a portion of said interest costs that are offset by actual gains realized on the assets of the employee pension plan.

9. The method of claim 7, wherein said operating expenses do not include charges associated with impairment of goodwill of the business enterprise.

10. A method for assessing economic earnings of a business enterprise for a given period by aggregating specified revenues and specified expenses incurred by the business enterprise during the course of the given period, said method comprising:
(a) excluding goodwill impairment expenses;
(b) excluding gains or losses from the sale of asset of the business enterprise if the stipulated commercial activities of the business enterprise do not entail selling a portion of its assets;
(c) excluding gains realized by the employee pension plan;
(d) excluding litigation settlements;
(e) excluding insurance proceeds; and
(f) excluding reversals of prior period charges and reversals of prior period provisions incurred in a period preceding the given period, wherein if an item is excluded from assessing the business enterprise's earnings, it is not counted in calculating the earnings.

11. The method of claim 10, further comprising including one or more of:
(a) expenses associated with granting stock options to employees of the business enterprise;
(b) expenses associated with restructuring ongoing commercial operations of the business enterprise;
(c) write-downs of depreciable or amortizable operating assets of the business enterprise;
(d) at least a portion of the costs associated with the administration of an employee pension plan;
(e) purchased research and development expenses;
(f) expenses related to mergers and acquisitions; and
(g) unrealized gains and losses from hedging activities, wherein if an item is included in assessing the business enterprise's earnings, it is counted in calculating the earnings.

12. A method for assessing economic earnings of a business enterprise for a given period by aggregating specified revenues and specified expenses incurred by the business enterprise during the course of the given period, said method comprising excluding one or more of:
(a) gains realized by an employee pension plan;
(b) litigation settlements;
(c) insurance proceeds; and
(d) reversals of prior period charges and reversals of prior period provisions incurred in a period preceding the given period, wherein if an item is excluded from assessing the business enterprise's earnings, it is not counted in calculating the earnings.

13 The method of claim 12, further comprising excluding one or more of:
(a) expenses associated with impairment of goodwill of the business enterprise; and
(b) gains or losses from sales of assets of the business enterprise if the stipulated commercial activities of the business enterprise do not entail selling a portion of its assets.

14. The method of claim 12, further comprising including one or more of:
(a) expenses associated with granting employee stock options;
(b) restructuring expenses from ongoing operations;
(c) write-downs of depreciable or amortizable operational assets;
(d) at least a portion of the costs incurred in the administration of an employee pension plan;
(e) purchased research and development expenses;
(f) expenses related to mergers and acquisitions; and
(g) unrealized gains and losses from hedging activities, wherein if an item is included in assessing the business enterprise's earnings, it is counted in calculating the earnings.
